(19) United States
(12) Patent Application Publication
(10) Pub. No.: US 2022/0058476 A1
(43) Pub. Date: Feb. 24, 2022

(54) METHODS AND APPARATUS FOR DYNAMIC SHADER SELECTION FOR MACHINE LEARNING

(71) Applicant: QUALCOMM Incorporated, San Diego, CA (US)

(72) Inventors: Balaji CALIDAS, San Diego, CA (US); Michael Collins GALLASPY, San Diego, CA (US); Diego MARTINEZ, San Diego, CA (US)

(21) Appl. No.: 16/997,834

(22) Filed: Aug. 19, 2020

(51) Int. Cl. G06N 3/08; G06N 20/00; G06T 15/00; G06T 1/20

(52) U.S. Cl. CPC G06N 3/08; G06T 1/20; G06T 15/005; G06N 20/00

(57) ABSTRACT

The present disclosure relates to methods and apparatus for selecting a sequence of shaders for performing a machine-learning operation on a graphics processing unit (GPU). The apparatus can receive a request to perform a machine-learning operation. The apparatus can determine a plurality of sequences of shaders that are capable of performing the machine-learning operation. The apparatus can determine a cost for each sequence of the plurality of sequences of shaders based on a cost function associated with each shader. The apparatus can execute a selected sequence of shaders of the plurality of sequences of shaders having a lowest cost.

### TECHNICAL FIELD

The present disclosure relates generally to processing systems and, more particularly, to one or more techniques for selecting shaders to perform a machine learning operation in a graphics processing unit (GPU).

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform graphics processes in a graphics processing pipeline. However, a GPU may also be used to perform machine learning operations by, for example, using shader logic units or dedicated logic cores to perform the machine learning operations in the graphics processing pipeline. Therefore, there has developed an increased need for improved utilization of system resources, such as shader logic units or dedicated logic cores, to perform machine learning operations by GPUs.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a graphics processing unit (GPU). The apparatus may include a memory and at least one processor coupled to the memory. The at least one processor may be configured to receive a request to perform a machine-learning operation. The at least one processor may be configured to determine a plurality of sequences of shaders that are capable of performing the machine-learning operation. The at least one processor may be configured to determine a cost for each sequence of the plurality of sequences of shaders based on a cost function associated with each shader. The at least one processor may be configured to execute a selected sequence of shaders having a lowest cost of the plurality of sequences of shaders.

In some implementations, the request to perform the machine-learning operation includes operation parameters and a plurality of tensors, each tensor associated with a tensor size.

In some implementations, the plurality of tensors include at least one of an input tensor, a weight tensor, a bias tensor, or an output tensor.

In some implementations, the plurality of tensors include at least one of a mean tensor, a variance tensor, a parameter tensor, or a scale tensor.

In some implementations, the cost function associated with at least one of the shaders is a function of the operation parameters and at least one tensor size.

In some implementations, the at least one processor is configured to: determine cost for each shader of a plurality of shaders within the one sequence based on the cost function associated with each shader; and determine a sum of the costs for the plurality of shaders within the one sequence.

In some implementations, at least one of the plurality of sequences of shaders includes an input conversion shader, a core shader, and an output conversion shader.

In some implementations, the cost function determines a runtime cost of the selected sequence for performing the machine-learning operation.

In some implementations, the machine-learning operation is a machine-learning layer of a neural network.

In some implementations, the at least one processor is configured to apply a rule filter to a library of sequences to determine the plurality of sequences of shaders that are capable of performing the machine-learning operation.

In some implementations, the apparatus is a wireless communication device.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content processing system configured to implement one or more techniques of this disclosure.

FIG. 2 illustrates an example of a graphics texture pipeline in accordance with one or more techniques of this disclosure.

FIG. 3 is a diagram illustrating an example implementation of a machine-learning (ML) model using graphics processing unit (GPU) shaders in accordance with one or more techniques of this disclosure.

FIG. 4 is a diagram illustrating selection of sequences of shaders in accordance with one or more techniques of this disclosure.

FIG. 5 is a diagram illustrating a cost function for a sequence of shaders in accordance with one or more techniques of this disclosure.

FIG. 6 is a flow diagram showing an example process for selecting a sequence of shaders for an ML operation in accordance with one or more techniques of this disclosure.

FIG. 7 is a flowchart illustrating an example method of selecting a sequence of shaders for an ML operation in accordance with one or more techniques of this disclosure.

### DETAILED DESCRIPTION

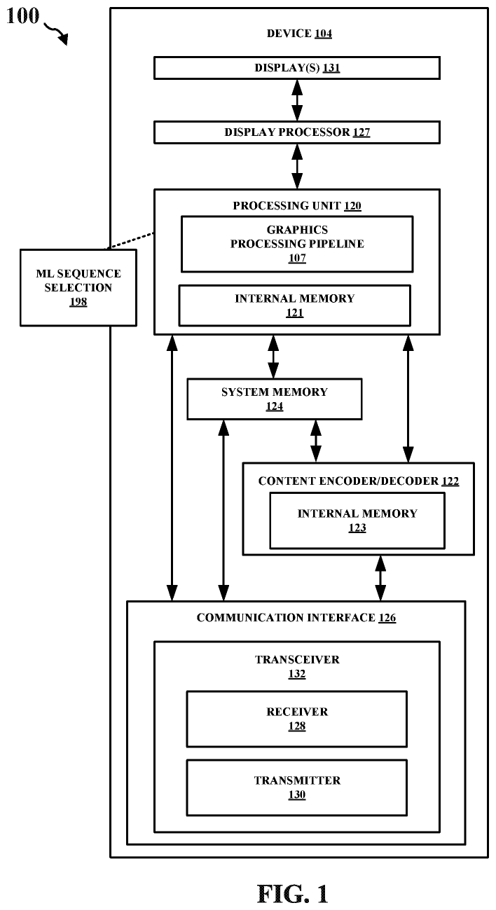

Generally, a graphics processing unit (GPU) is a specialized electronic circuit designed to rapidly manipulate and alter memory to accelerate the creation of images in a frame buffer intended for output to a display device. GPUs can be embedded in systems, mobile phones, personal computers, workstations, head-mounted displays (HMDs), vehicle displays, and the like, as described in detail below with respect to FIG. 1. The highly parallel structure of GPUs generally makes them more efficient than general-purpose central processing units (CPUs) to process large blocks of data in parallel. Additionally, the structure of GPUs may also be suitable for machine-learning (ML) algorithms and architectures. For instance, some ML algorithms may use convolution, activation, matrix multiplication, or other for machine learning operations, which may be implemented on GPUs using shaders. As used herein, the term “shader” refers to a program configured to execute on a GPU. The term “kernel,” when used in the context of a GPU, may also refer to program configured to execute on the GPU and may alternatively be referred to as a shader. A library of shaders may be provided by one or more application programming interfaces (APIs). For example, APIs including shaders include OpenCL, OpenGL, Vulkan, and DirectX (DX). A group of interdependent shaders may be referred to as a sequence of shaders. A sequence of shaders may include one or more shaders. An ML algorithm may be implemented as an ML model including a plurality of layers. Each layer may be implemented by an ML operation.

In some GPUs, there may be multiple possible sequences of shaders for performing an ML operation. For example, some shaders may operate on an image while other shaders may operate on a buffer to perform similar operations. Other shaders such as conversion shaders may convert between input types. Accordingly, one sequence may include a single shader that operates on an input data type while another sequence may use a first conversion shader to change the input data type, a core shader to perform the ML operation, and a second conversion shader to change an output type. Although two or more sequences of shaders may be capable of performing an ML operation, some sequences of shaders may be more efficient or perform the ML operation at a lower cost (e.g., runtime). Accordingly, overall cost of an ML model may be improved by selecting a sequence of shaders for each ML operation that has a lowest cost.

One strategy for selecting a sequence of shaders for an ML operation is to select shaders based on a level of specialization for an ML operation, which may correlate with efficiency. The level of specialization may be static such that a bid for the shader may be easily determined based on the ML operation. This strategy, however, poses problems for sequences of shaders where more general conversion shaders are used in combination with specialized shaders. Additionally, the cost of a shader may depend on run-time parameters such as input and output size. Accordingly, selection based on static levels of specialization may not select the best sequence of shaders.

In an aspect, the present disclosure provides for dynamic selection of shaders for machine learning operations using a cost function for each shader. A processing system may receive a request to perform a machine-learning operation. For example, the machine-learning operation may correspond to a layer of a machine-learning model such as an artificial neural network. The processing system may determine a plurality of sequences of shaders that are capable of performing the machine-learning operation. For example, the processing system may apply a rule filter to a library of shaders to determine the plurality of sequences of shaders. The processing system may determine the cost for each sequence of the plurality of sequences of shaders based on the cost function associated with each shader. The cost function may be a function of run-time parameters for the machine-learning operation. For example, the cost function may be based on operation parameters and tensor size. The cost for a sequence of shaders may be based on a sum of the costs for each shader in the sequence. The processing system may select a sequence of shaders having a lowest cost. The GPU may perform the machine-learning operation using the selected sequence of shaders. Accordingly, the GPU may efficiently perform the machine-learning operation.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein, one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different technologies, system configurations, networks, and processing protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, and the like, whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, analyzing graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content processed by one or more processes of a graphics processing pipeline.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

FIG. 1 is a block diagram that illustrates an example content processing system 100 configured to implement one or more techniques of this disclosure. The content processing system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. In further examples, the results of the graphics processing may not be displayed on the device, e.g., the first and second display may not receive any frames for presentment thereon. Instead, the frames or graphics processing results may be transferred to another device.

According to an exemplary aspect, the processing unit 120 may include an internal memory 121. Moreover, in the exemplary aspect, the processing unit 120 is configured to perform graphics processing, i.e., in graphics processing pipeline 107 as will be discussed in more detail below. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

In an exemplary aspect, the internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104.

According to an aspect, the graphics processing pipeline 107 of the processing unit 120 includes one or more arithmetic logic units (ALUs), and specifically one or more graphics texture ALUs that are configured to perform texture filtering to determine texture colors for texture mapped pixels based on colors of nearby texels (i.e., pixels of the texture). As will be described in detail below, the processing unit 120 can execute machine-learning shaders that may cause the one or more graphics texture ALUs to perform machine-learning operations according to an exemplary aspect.

It is further noted that if the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), ALUs, digital signal processors (DSPs), video processors, discrete logic, software, hardware, firmware, other equivalent integrated or discrete logic circuitry, or any combinations thereof If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content processing system 100 can include an optional communication interface 126. The communication interface 126 may include a receiver 128 and a transmitter 130. The receiver 128 may be configured to perform any receiving function described herein with respect to the device 104. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104. In an exemplary aspect, the transmitter 130 may be configured to transmit the output result from the processing unit 120 to a programmable shader (not shown in FIG. 1) that can be configured for specialized functions, such as any type of video image post-processing.

Referring again to FIG. 1, the processing unit 120 can include a ML sequence selection 198 configured to select a sequence of shaders for performing an ML operation using the graphics processing pipeline 107. That is, the processing unit 120 may be configured to perform a ML operation such as a layer of a ML model using the graphics processing pipeline 107. For example, the graphics processing pipeline 107 may be configured with a plurality of shaders for performing ML operations. In some implementations, the plurality of shaders may be described by an application programming interface (API). The ML sequence selection 198 may determine a plurality of sequences of shaders that are capable of performing the machine-learning operation. The ML sequence selection 198 may determine a cost of each sequence of the plurality of sequences of shaders based on a cost function associated with each shader. The ML sequence selection 198 may execute a selected sequence of shaders having a lowest cost of the plurality of sequences of shaders. In one or more example implementations, the ML sequence selection 198 may be implemented in hardware, software, or any combination thereof.

In general, it is noted that a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

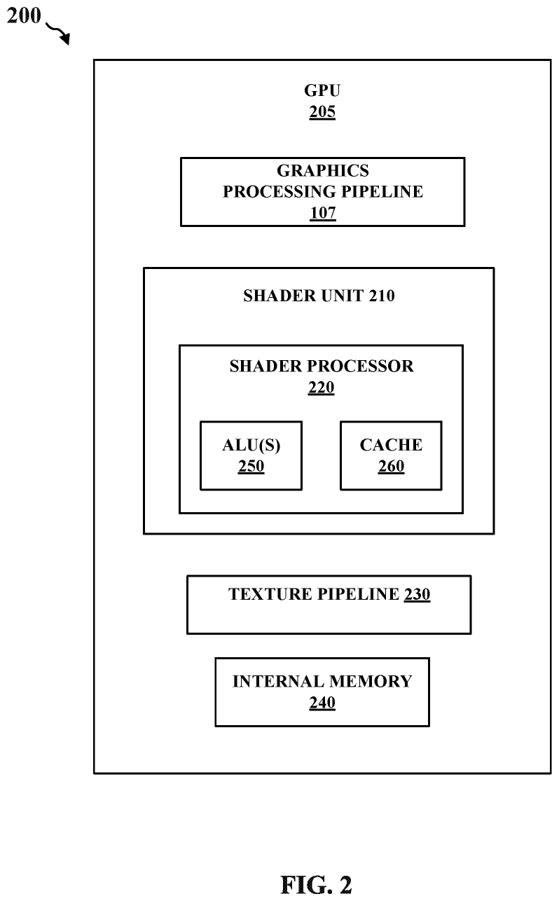

FIG. 2 is a block diagram 200 that illustrates an example GPU 205 in accordance with one or more techniques of this disclosure. In general, the GPU 205 can correspond to an example of the processing unit 120 (or a component therein) as described above with respect to FIG. 1. For example, the processing unit 120 can be a GPU, which, as an example, can be a specialized electronic circuit that rapidly manipulates and alters memory to accelerate the creation of images in a frame buffer intended for output to a display device, such as display 131.

In addition, FIG. 2 shows an aspect in which the processing unit 120 comprises a GPU 205 to perform the respective image processing operations. Specially, in an aspect, GPU 205 may be configured to perform graphics operations to render one or more graphics to display 131, as described above. In a typical operation, when one of the software applications executing on the device 104 requires graphics processing, the processing unit 120 may provide graphics commands and graphics data to GPU 205 for rendering to display 131. The graphics data may include texture information, drawing commands, and the like. As also described above, GPU 205 may be built with a highly-parallel structure that provides more efficient processing of complex graphic related operations.

As shown, GPU 205 may include a plurality of processing elements, such as one or more shader units (i.e., shader unit 210), that are configured to operate on multiple vertices or pixels in a parallel manner. Moreover, GPU 205 may include internal memory 240 (e.g., corresponding to internal memory 121 of FIG. 1), such that GPU 205 may read data from and write data to directly to internal memory 240 without using a bus. In other words, GPU 205 may process data locally using a local storage, instead of off-chip memory. This configuration will enable GPU 205 to operate in a more efficient manner by eliminating the need of GPU 205 to read and write data via a bus, which may experience heavy bus traffic. In some instances, however, GPU 205 may not include a separate memory, but instead utilize system memory 124 via a bus.

In an aspect, internal memory 240 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), Flash memory, a magnetic data media or an optical storage media. In addition, internal memory 240 may be coupled to cache 260 of shader unit 210, the details of which will be described below.

As further shown in FIG. 2, GPU 205 includes the one or more shader units 210, graphics processing pipeline 107, and texture pipeline 230. Moreover, one or more shader programs may execute on shader units 210 in GPU 205. Shader units 210 may also include one or more shader processors 220, each of which may include one or more components for fetching and decoding operations, one or more arithmetic logic units (ALUs) 250 for carrying out arithmetic calculations, one or more caches 260, or more generally other types of memory and/or registers.

In a typical operation, GPU 205 may designate the one or more shader units 210 to perform a variety of shading operations such as vertex shading, hull shading, domain shading, geometry shading, pixel shading, and the like by sending commands to shader units 210 to execute one or more of a vertex shader stage, a hull shader stage, a domain shader stage, a geometry shader stage, and a pixel shader stage in graphics processing pipeline 107. For an ML operation, the GPU 205 may similarly designate the one or more shader units 210 to perform one or more ML operations using shaders. Example ML operations include: convolution, batch normalization, pooling, concatenation, fully connected, softmax, reshape, permute, LSTM, GRU, depthwise separable convolution, transpose convolution, and depth to space. An ML operation may be implemented by executing one or more shaders such as core shaders, conversion shaders, convolution shaders, activation shaders, etc. In some implementations, each ML operation may be implemented with a specific shader or a sequence of more general purpose shaders. The GPU 205 may send commands to the shader units 210 to execute a sequence of shaders for the ML operation. In an aspect, because there may be multiple sequences of shaders capable of performing an ML operation, selection of a lowest cost sequence may improve performance of the GPU 205 by completing the ML operation more quickly and making resources such as the shader units 210 more available.

Referring back to FIG.1 the ML sequence selection 198 is configured to select the sequence of shaders for an ML operation. The ML sequence selection 198 may receive a request to perform a machine-learning operation (e.g, from processing unit 120). The ML sequence selection 198 may determine a plurality of sequences of shaders that are capable of performing the machine-learning operation. The ML sequence selection 198 may determine a cost for each sequence of the plurality of sequences of shaders based on a cost function associated with each shader. The ML sequence selection 198 may execute (e.g., on the GPU 205) a selected sequence of shaders having a lowest cost of the plurality of sequences of shaders.

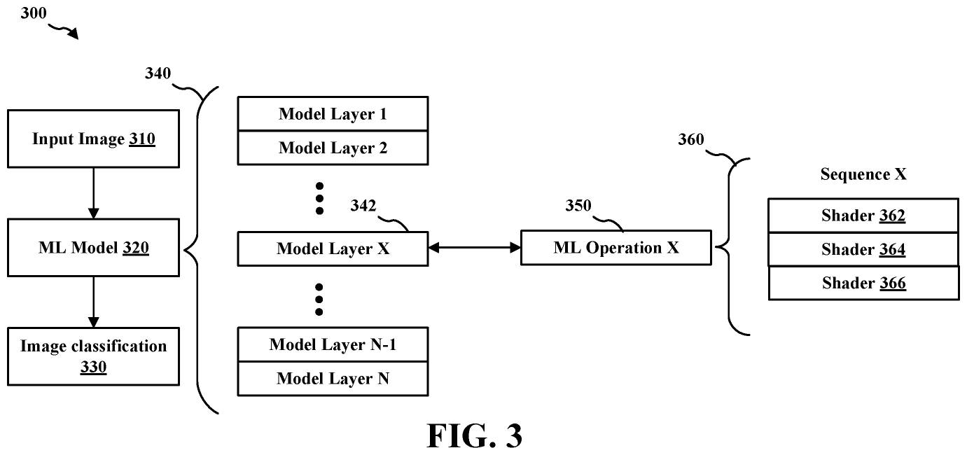

FIG. 3 is a diagram 300 illustrating an example implementation of a ML model 320 using a sequence of GPU shaders. For example, the ML model 320 may perform an image processing operation such as image recognition. For instance, as illustrated, the ML model 320 may receive an input image 310 and output an image classification 330. The present disclosure, however, is not limited to machine-learning for image processing and other ML models and ML operations may be performed on a GPU using the techniques disclosed herein. For example, a deep neural network (DNN) may be an artificial neural network (ANN) with multiple layers between the inputs and outputs. The DNN determines the correct mathematical manipulation to turn the input into the output and moves through the multiple layers to calculate the probability of each output. For instance, in the case of image recognition, the image classification may be an output associated with a highest probability.

In an aspect, the ML model 320 may be implemented as a series of layers 340. Each layer 340 may be associated with an ML operation. For example, the model layer X 342 may be associated with an ML operation 350. In some implementations, a ML operation such as the ML operation 350 may be associated with an object such as a tensor flow. The ML operation 350 may be performed on a GPU by executing a sequence X 360 of shaders capable of performing the ML operation 350. For example, the sequence X 360 may include three shaders: shader 362, shader 364, and shader 366. In some implementations, the shaders 362, 364, 366 each may be an OpenCL shader, but in other implementations may be provided by a different library. In the illustrated example, shader 362 may perform a pre-processing operation to convert an input into a format for shader 364. The shader 364 may be a core shader configured to perform a core operation. The shader 366 may convert the output of the shader 364 to an output form for the ML operation 350. For example, in some implementations, the input may be in the form of a tensor including data stored in memory. The data may be, for example, an image or a buffer. In this context images and buffers are different ways for the GPU to view tensor data in memory. The GPU may use a different hardware block to access data as an image as opposed to data as a buffer. For instance, two core shaders defined for different input tensors may execute on different hardware, which may contribute to differences in cost (e.g., run time).

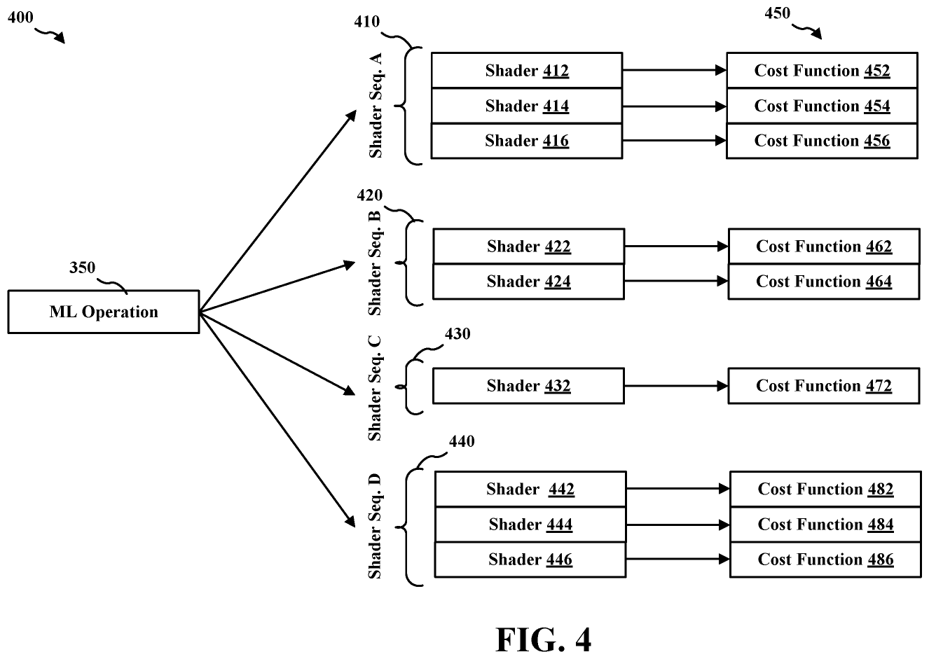

FIG. 4 is a diagram 400 illustrating selection among sequences of shaders. In an aspect, a library of shaders such as an API may include multiple sequences of shaders that are capable of performing an ML operation. A filtering process using a rule filter may be used to select sequences that are capable of performing an ML operation. For example, the filtering process may match a core function, and select conversion shaders to match inputs and outputs. The filtering process may provide multiple sequences of shaders. For example, in an implementation, the ML operation 350 may be associated with four sequences 410, 420, 430, and 440 that are capable of performing the ML operation. Each sequence 410, 420, 430, and 440 may include one or more shaders. For example sequence A 410 may include three (3) shaders 412, 414, 416, sequence B 420 may include two (2) shaders 422, 424, sequence C 430 may include one (1) shader 432, and sequence D 440 may include three (3) shaders 442, 444, 446. The number of shaders may not be indicative of a cost of a sequence. For example, although sequence C 430 includes only one shader, that shader may be a general purpose shader with a long run-time. In contrast, sequence A 410 may include three shaders, where the first shader is a conversion shader, the second shader is a specialized shader (or core shader) for performing the ML operation, and the third shader is another conversion shader. For small sets of data or small tensor sizes, the conversion shaders may execute relatively quickly. The specialized shader for the ML operation may also execute relatively quickly compared to a general purpose shader. Accordingly, depending on the operation parameters of the ML operation 350 and the size of the input (e.g., tensor size), the sequence A 410 may have a lower cost than the sequence C 430. Similarly, the sequence B 420 or the sequence D 440 may have a lower cost.

In an aspect of the present disclosure, a cost function may be associated with each shader. For example, the cost functions 452, 454, 456 may correspond to the shaders 412, 414, 416, respectively, the cost functions 462, 464 may correspond to the shaders 422, 424 respectively, the cost function 472 may correspond to the shader 432, and the cost functions 482, 484, 486 may correspond to the shaders 442, 444, 446, respectively. As discussed in further detail below, the cost function may be a function of parameters such as operation parameters and tensor sizes. Accordingly, the cost function may provide a more accurate cost estimation than a static level of specialization. The cost estimates for multiple shaders in a sequence may be summed to determine a cumulative cost for the sequence. The cumulative costs for the sequences may be compared to determine a lowest cost sequence for performing the ML operation.

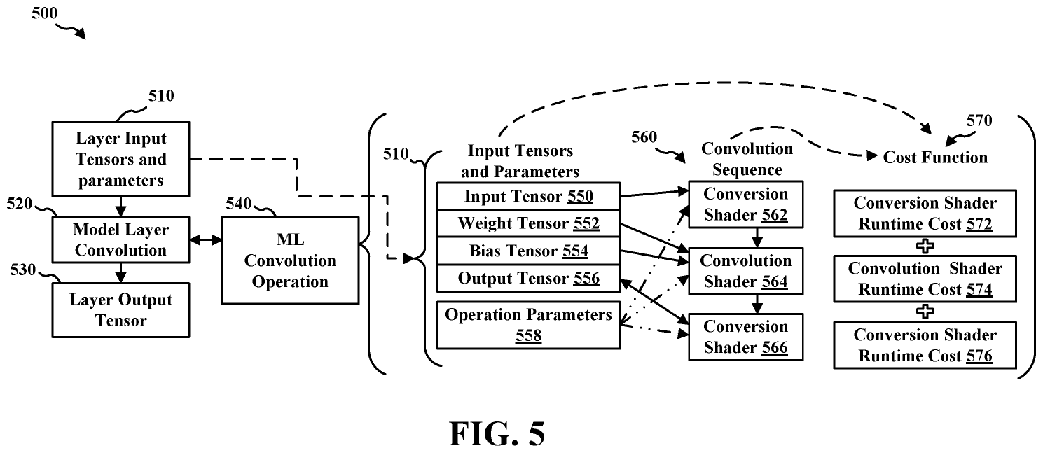

FIG. 5 is a diagram 500 illustrating determination of a cost function 570 for a sequence of shaders. As discussed above, an ML operation may implement a layer of an ML model. The input to the layer of the ML model may include input tensors and parameters 510. The layer may be, for example, a convolution layer 520. The output of the layer may be a layer output tensor 530. The convolution layer 520 may correspond to an ML convolution operation 540, which may be an example of the ML operation 350. For the ML convolution operation 540 the input tensors and parameters 510 may include an input tensor 550, a weight tensor 552, a bias tensor 554, an output tensor 556, and operation parameters 558. Each tensor may have a tensor size. The size of the input tensor 550 and the output tensor 556 may depend on the inputs and outputs to the layer. The weight tensor 552 and the bias tensor 554 may include learned parameters of the ML model. Other ML operations may be associated with different sets of tensors including different tensor types such as a mean tensor, a variance tensor, a parameter tensor, or a scale tensor. For example, a fully connected operation may be associated with an input tensor, an output tensor, a weight tensor, and an optional bias tensor. As another example, a concatenation operation may include at least one input tensor (e.g., 1-N input tensors) and an output tensor. As another example, a batch norm operation may include an input tensor, an output tensor, a scale tensor, a bias tensor, a mean tensor, and a variance tensor. As another example, an activation operation may include an input tensor, an output tensor, and an optional parameter tensor. As another example, an elementwise add operation may include a first input tensor, an optional second input tensor, and an output tensor.

In an aspect, a runtime cost of each shader may be a function of the input tensors and parameters 510. For example, in some implementations, the runtime cost of a shader may be a function of the operation parameters 558 and a size of one or more of the input tensor 550, the weight tensor 552, the bias tensor 554, or the output tensor 556.

For example, a convolution sequence 560 may be capable of performing the ML convolution operation 540. The convolution sequence 560 may include a conversion shader 562, a convolution shader 564, and a conversion shader 566. The conversion shader 562 may operate on the input tensor 550. As such, a conversion shader runtime cost 572 may depend on a size of the input tensor 550 and operation parameters 558. The convolution shader 564 may operate on output from the conversion shader 562, the weight tensor 552, and the bias tensor 554. Accordingly, the convolution shader runtime cost 574 may be a function of the size of the weight tensor 552, the size of the bias tensor 554, and the operation parameters 558. The conversion shader 566 may operate on the output tensor 556. Accordingly, the conversion shader runtime cost 576 may be a function of the length of the output tensor 556 and the operation parameters 558. The cost function 570 may be a sum of the conversion shader runtime cost 572, the convolution shader runtime cost 574, and the conversion shader runtime cost 576. It should be appreciated that the convolution sequence 560 is an example of one possible sequence of shaders. Other sequences for performing the convolution operation may include different numbers of shaders. Conversion shaders or kernels may occur at any point in a sequence. In some implementations, the cost function for a shader depends on only the input tensors and parameters. In some implementations, the cost function 570 may be an unweighted sum of the individual cost functions of the shaders in a sequence. That is, the number or type of shaders may not directly affect the cost function 570. Accordingly, a sequence with multiple shaders may have a lower cost function than a sequence with a single shader.

Although an example of a convolution sequence 560 is illustrated, other sequence and shaders may operate on different input tensors and parameters 510. For example, an activation operation may include only an input tensor 550 and an output tensor 556. A cost function for an activation shader may be a function of a size of the input tensor 550, a size of the output tensor 556, and the operation parameters 558.

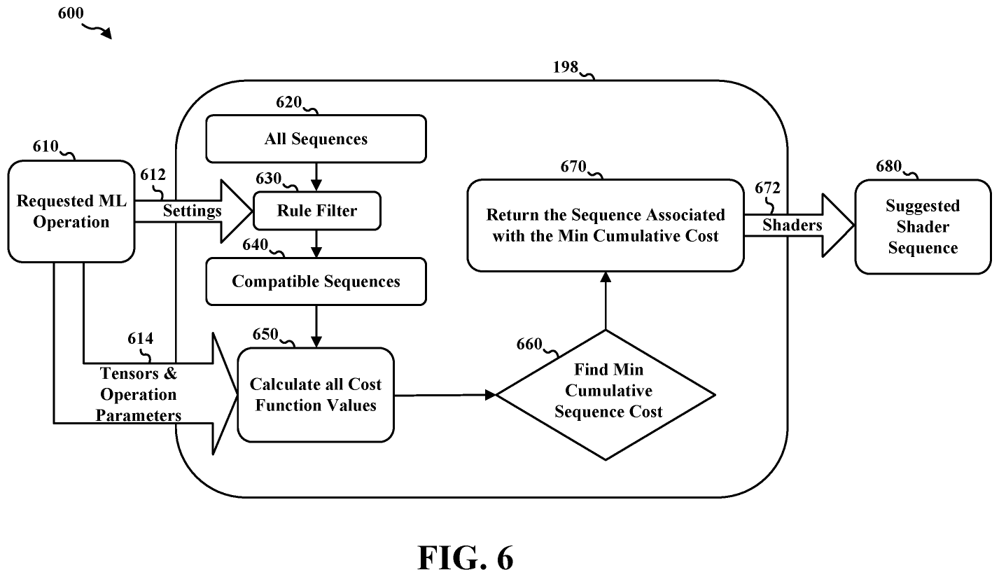

FIG. 6 is a flow diagram showing an example process 600 for selecting a sequence of shaders for an ML operation. The process 600 may be performed by the ML sequence selection 198. The ML sequence selection 198 may receive a requested ML operation 610. For example, the processing unit 120 may be configured to process a ML model and may be configured to use the graphics processing pipeline 107 to accelerate the requested ML operation 610. The requested ML operation 610 may be associated with settings 612 and a set of tensors and operation parameters 614. The ML sequence selection 198 may be configured with a set of sequences 620 and a rule filter 630. For example, the set of sequences 620 may be a library of shaders provided by one or more APIs. The ML sequence selection 198 may apply the settings 612 and the set of sequences 620 to the rule filter 630 to determine a set of compatible sequences 640. Each sequence of shaders in the set of compatible sequences 640 may be capable of performing the requested ML operation 610.

In an aspect, the rule filter 630 includes validation rules. The validation rules are parameterized, meaning that validation rule is a rule with a general form that can be slotted with particular values in order to create a rule for a specific condition. Each shader sequence exports a set of rules that must be satisfied in order for that sequence to produce correct output. These rules relate to key attributes of ML operations and the tensors attached to those operations. For each sequence, these rules are applied to the incoming operation and the attached tensors. The shader sequence is considered compatible if all of its rules apply successfully. Some examples of these rules include tensor property rules and operation property rules. Tensor property rules check that a particular property for a specific tensor that is referenced by the operation matches a predefined value. For example, the operation as specified, must have an input tensor with layout matching an Image Layout A. Another example of a tensor property rule is that the weight tensor size in the channel dimension should be a multiple of 4. Operation property rules check that a specific parameter of the operation has values that fall within a specified set. For example, the arithmetic mode for the operation should be 32-bit floating point. Another rule could be that the filter application stride should be 1 in all dimensions.

The ML sequence selection 198 may execute block 650 to calculate all cost function values. For example, as discussed above, each shader may be associated with a corresponding cost function. In some implementations, the cost function may be defined by the API that defines the shader. In other implementations, the cost function may be separately defined, for example, based on empirical testing. The block 650 may include summing cost function values (e.g., costs) of individual shaders to determine a cumulative sequence cost. In block 660, the ML sequence selection 198 may find a minimum cumulative sequence cost of the compatible sequences 640. In block 670, the ML sequence selection 198 may return the sequence associated with the minimum cumulative cost. For example, the ML sequence selection 198 may output a sequence of shaders 672 as a suggested shader sequence 680.

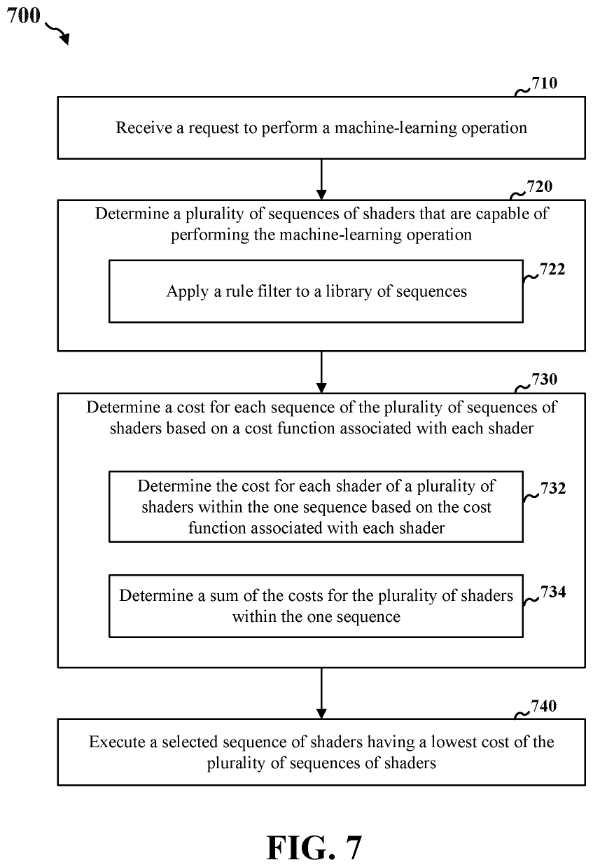

FIG. 7 is a flowchart illustrating an example method 700 of selecting a sequence of shaders for an ML operation in accordance with one or more techniques of this disclosure. The method 700 may be performed by an apparatus including the ML sequence selection 198. For example, the apparatus may be the device 104 including the processing unit 120, ML sequence selection 198, graphics processing pipeline 107, and/or GPU 205, as described above.

At block 710, the method 700 may include receiving a request to perform a machine-learning operation. In an aspect, for example, the ML sequence selection 198 may receive a request (e.g., requested ML operation 610) to perform the machine-learning operation (e.g., ML operation 350). In some implementations, the machine-learning operation is a machine-learning layer of a neural network. The request to perform the machine-learning operation may include operation parameters and a plurality of tensors (e.g., input tensors and parameters 510). Each tensor may be associated with a tensor size. For instance, the plurality of tensors may include at least one of the input tensor 550, the weight tensor 552, the bias tensor 554, or the output tensor 556.

At block 720, the method 700 may include determining a plurality of sequences of shaders that are capable of performing the machine-learning operation. In an aspect, for example, the ML sequence selection 198 may determine the plurality of sequences of shaders (e.g., sequences 410, 420, 430, 440 or compatible sequences 640) that are capable of performing the machine-learning operation 350. For example, at sub-block 722, the ML sequence selection 198 may apply the rule filter 630 to a library of sequences (e.g., all sequences 620) to determine the compatible sequences 640. In some implementations, at least one of the plurality of sequences of shaders includes an input conversion shader, a convolution shader, and an output conversion shader.

At block 730, the method 700 may include determining a cost for each sequence of the plurality of sequences of shaders based on a cost function associated with each shader. In an aspect, for example, the ML sequence selection 198 may determine a cost for each sequence of the plurality of sequences 410, 420, 430, 440, based on a cost function 450 associated with each shader. In some implementations, the cost function 570 associated with at least one of the shaders is a function of the operation parameters 558 and at least one tensor size (e.g., a size of input tensor 550, weight tensor 552, bias tensor 554, or output tensor 556). In some implementations, at sub-block 732, the block 730 may include determining a cost 572, 574, 576 for each shader 562, 564, 566 of a plurality of shaders within the one sequence (e.g., convolution sequence 560) based on the cost function 570 associated with each shader. At sub-block 734, the block 730 may include determining a sum of the costs for the plurality of shaders within the one sequence. For example, the ML sequence selection 198 may determine a sum of the costs 572, 574, and 576.

At block 740, the method 700 may include executing a selected sequence of shaders of the plurality of sequences of shaders having a lowest cost. In an aspect, for example, the ML sequence selection 198 may issue a command to the graphics processing pipeline 107 and/or the GPU 205 to execute the selected sequence of shaders (e.g., suggested shader sequence 680) of the plurality of sequences of shaders having a lowest cost.

Effectively, the subject matter described herein can be implemented to realize one or more benefits or advantages. For instance, the techniques disclosed herein enable selection of a lowest cost sequence for performing an ML operation on a GPU using a sequence of shaders. As a result the apparatus and method may perform the ML operation more quickly or more efficiently than if other sequences are selected. Thus, the processing techniques herein can improve or speed up data processing or execution and also improve resource or data utilization and/or resource efficiency.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of intraoperative hardware units, including one or more processors as described above, in conjunction with suitable software and/or firmware.

Various examples have been described. These and other examples are within the scope of the following claims.

What is claimed is:

1. A method of performing a machine-learning operation, comprising:
receiving a request to perform a machine-learning operation;
determining a plurality of sequences of shaders that are capable of performing the machine-learning operation;
determining a cost for each sequence of the plurality of sequences of shaders based on a cost function associated with each shader; and
executing a selected sequence of shaders having a lowest cost of the plurality of sequences of shaders.

2. The method of claim 1, wherein the request to perform the machine-learning operation includes operation parameters and a plurality of tensors, each tensor associated with a tensor size.

3. The method of claim 2, wherein the plurality of tensors include at least one of an input tensor, a weight tensor, a bias tensor, or an output tensor.

4. The method of claim 2, wherein the plurality of tensors include at least one of a mean tensor, a variance tensor, a parameter tensor, or a scale tensor.

5. The method of claim 2, wherein the cost function associated with at least one of the shaders is a function of the operation parameters and at least one tensor size.

6. The method of claim 1, wherein determining the cost for at least one sequence of the plurality of sequences comprises:
determining a cost for each shader of a plurality of shaders within the at least one sequence based on the cost function associated with each shader; and
determining a sum of the costs for the plurality of shaders within the one sequence.

7. The method of claim 1, wherein at least one of the plurality of sequences of shaders includes an input conversion shader, a core shader, and an output conversion shader.

8. The method of claim 1, wherein the cost function determines a runtime cost of the selected sequence for performing the machine-learning operation.

9. The method of claim 1, wherein the machine-learning operation is a machine-learning layer of a neural network.

10. The method of claim 1, wherein determining the plurality of sequences of shaders that are capable of performing the machine-learning operation comprises applying a rule filter to a library of sequences of shaders.

11. An apparatus for machine-learning, comprising:
a memory; and
at least one processor coupled to the memory and configured to:
receive a request to perform a machine-learning operation;
determine a plurality of sequences of shaders that are capable of performing the machine-learning operation;
determine a cost for each sequence of the plurality of sequences of shaders based on a cost function associated with each shader; and
execute a selected sequence of shaders having a lowest cost of the plurality of sequences of shaders.

12. The apparatus of claim 11, wherein the request to perform the machine-learning operation includes operation parameters and a plurality of tensors, each tensor associated with a tensor size.

13. The apparatus of claim 12, wherein the plurality of tensors include at least one of an input tensor, a weight tensor, a bias tensor, or an output tensor.

14. The apparatus of claim 12, wherein the plurality of tensors include at least one of a mean tensor, a variance tensor, a parameter tensor, or a scale tensor.

15. The apparatus of claim 12, wherein the cost function associated with at least one of the shaders is a function of the operation parameters and at least one tensor size.

16. The apparatus of claim 11, wherein the at least one processor is configured to:
determine cost for each shader of a plurality of shaders within the one sequence based on the cost function associated with each shader; and
determine a sum of the costs for the plurality of shaders within the one sequence.

17. The apparatus of claim 11, wherein at least one of the plurality of sequences of shaders includes an input conversion shader, a core shader, and an output conversion shader.

18. The apparatus of claim 11, wherein the cost function determines a runtime cost of the selected sequence for performing the machine-learning operation.

19. The apparatus of claim 11, wherein the machine-learning operation is a machine-learning layer of a neural network.

20. The apparatus of claim 11, wherein the at least one processor is configured to apply a rule filter to a library of sequences to determine the plurality of sequences of shaders that are capable of performing the machine-learning operation.

21. The apparatus of claim 11, wherein the apparatus is a wireless communication device.

22. A non-transitory computer-readable medium storing computer executable code, the code when executed by a processor of a graphics processing unit (GPU), causes the processor to:
receive a request to perform a machine-learning operation;
determine a plurality of sequences of shaders that are capable of performing the machine-learning operation;
determine a cost for each sequence of the plurality of sequences of shaders based on a cost function associated with each shader; and
execute a selected sequence of shaders having a lowest cost of the plurality of sequences of shaders.
